(19) United States
(12) Patent Application Publication
(10) Pub. No.: US 2023/0297550 A1
(43) Pub. Date: Sep. 21, 2023

(54) DYNAMIC DATA VIEWS

(71) Applicant: The Modern Data Company, Inc., Palo Alto, CA (US)

(72) Inventors: Animesh KUMAR, Indore (IN); Travis THOMPSON, Los Angeles, CA (US); Shubhanshu JAIN, Indore (IN)

(73) Assignee: The Modern Data Company, Inc., Palo Alto, CA (US)

(21) Appl. No.: 18/181,434

(22) Filed: Mar. 9, 2023

Related U.S. Application Data
(60) Provisional application No. 63/269,634, filed on Mar. 20, 2022.

(51) Int. Cl. G06F 16/21; G06F 16/26; G06F 16/25

(52) U.S. Cl. CPC G06F 16/212; G06F 16/26; G06F 16/258

(57) ABSTRACT

Embodiments describe approaches to creating dynamic data views of a data set. A dynamic data views (also referred to as logical data models or logical conveyances) allows users to visualize data or otherwise interact with data from a plurality of data resources (also referred to as physical data or source data) from various datastores across a domain (e.g., an enterprise, a unit within the enterprise, a company, etc.) Multiple dynamic data views can be derived from the same set of physical data and customized to meet the specific needs of different users, without altering the source data or changing its format or storage location. These data views can be generated, stored, and accessed on demand, and may be provided by various vendors. They may be shared, purchased, rented, or otherwise obtained, and may be based on one or more metrics that can be updated as necessary.

### CROSS-REFERENCE TO RELATED APPLICATIONS

This application is a continuation of U.S. Application No. 63/269,634, entitled “DYNAMIC DATA VIEWS,” filed Mar. 20, 2022, which the full disclosure of this application is incorporated herein by reference for all purposes.

### BACKGROUND

### Field of the Art

The present embodiments relate to data management. More specifically, the present embodiments relate to generating a map of situational awareness that enables viewing and accessing data from various locations, translated to user-friendly language, through a dynamic data lens.

### Discussion of the State of the Art

Organizations are striving to become truly data-driven. Stakeholders must be able to understand, trust and use data. The data management goals of such organizations include being able to create a map of situational awareness for stakeholders that allows stakeholders to see data from various locations, translated to business-friendly language, through a single lens. An organization may employ a variety of use cases relating to data management tools. Some of the most important use cases relate to data exploration and metrics. Objective measurements, commonly known as metrics, are a fundamental requirement to achieve data-driven decision making. For example, a business executive needs a metric to measure revenue growth. In another example, a machine needs a metric to measure how active a mobile app user is. Activating data is only possible if data is (1) easy to retrieve, (2) consistently defined across the domain, and (3) easy to reuse across use cases.

Data silos and limiting governance frameworks result in slow and complicated data retrieval. However, the biggest impediment is the “non-self-serve” nature of data pipelines. For example, a simple metric computation may require writing SQL queries that run into thousands of lines. Consumption and retrieval of data are thus typically done by different individuals in organizations. Due to a lack of a common data management interface, communication between business executives, data analysts, and data engineers is not straightforward. Even after appropriate datasets are established and governance policies are cross-checked, inefficient exchanges relating to data access and management still occur between the consumer, business executives, data analysts, and data engineers before everyone is satisfied with the resulting data.

A domain may include an entire organization or one of its units. As data usage has proliferated, the same dataset is often recomputed in a bespoke manner across a domain by multiple consumers. Multiple processes to retrieve such data commonly lead to inconsistency in definition and sources of the same metric, costing significant time and money due to the effort of reconciling conflicting reports. Creating a single repository for metrics could be a simple solution, but it is severely limiting with respect to composability (e.g., changing the week from Sunday to Saturday instead of Monday to Sunday).

Conventional data management typically results in data that is not easy to reuse across use cases. For example, many business intelligence (BI) tools come equipped with the capability of transforming data before it is surfaced. However, they do not allow the same datasets to be exported for utilization elsewhere. Thus, if a consumer needs to build an application powered by these datasets, they will have to be recomputed all over again outside the BI tool.

Organizations are investing heavily in data and analytics infrastructure, machine learning, tools for democratizing data, and access to analytics. This has helped spur a wave of tools across the data management ecosystem. These tools are primarily built to cater to a specific use case or persona and are only “point solutions”. Organizations stitch these point solutions together to create their data infrastructure. These data infrastructures require numerous integrations and services to patch point solutions together and keep them updated and maintained for daily operations. Increasingly, because of incorporating point solutions, data architectures have become far too rigid. Organizations often struggle to integrate, govern, process, and syndicate data to external entities to generate the value they desperately need. Most non-technology organizations are not getting value out of their data investments. Moreover, conventional data management techniques result in inconsistent metrics, inefficient and costly dependence on data engineering skill sets, slow iteration cycles, data quality concerns, and complicated data governance. Accordingly, improved data management and methods for providing bespoke data views are desired.

### SUMMARY

Systems and methods in accordance with various embodiments of the present disclosure may overcome one or more of the aforementioned and other deficiencies experienced in conventional approaches to data management. In particular, various embodiments describe approaches to creating dynamic data views of a data set. A dynamic data view (also referred to as a logical model or a logical conveyance) allows users to visualize data or otherwise interact with data from a plurality of data sources (also referred to as physical data or source data) from various data stores across a domain (e.g., an enterprise, a unit within the enterprise, a company, etc.)

In an example, a plurality of different dynamic data views can be derived from the same set of physical data, directed to a plurality of different users for each user's needs. The plurality of different dynamic data views is derived without moving or changing the source data regardless of the format or how the source data is stored. In this way, a user can request a particular view of data. The system can source the data, resolve compliance issues, manage security, and access the data.

In a specific example, approaches described herein provide for a system that utilizes a query language to retrieve data from the various data stores and organize it in a logical and easily understandable manner. The system includes a query engine that receives a query in the form of a structured query language (SQL) statement or similar language. The query engine then uses the query to retrieve data from the various data stores and organizes the data in a logical and easily understandable manner, such as in a table or other structured format. For example, a user may have data stored in multiple databases, such as a MySQL database and a MongoDB database. The user can use the dynamic data view system to generate a query that retrieves data from both of these databases and organizes it in a single table for easy analysis. Additionally, the system can also include a user interface that allows for the creation and modification of queries, as well as the ability to visualize the results of the query in a variety of formats, such as charts and graphs.

Embodiments of the present invention offer various technical and practical advantages compared to conventional data management approaches. For example, from a technical standpoint, managing and analyzing data in a networked computing environment can be challenging due to data fragmentation, complexity, and heterogeneity. However, the mapping component, loading component, and query component of the approaches described herein standardize the data and provide a structured view of the data set, allowing efficient querying and analysis of the data. Dynamic data views of a data set allow users to visualize and interact with data from various sources and data stores across a domain, without needing to move or change the underlying source data. This preserves the integrity of the original data, avoids potential data loss or corruption, and reduces the time and cost associated with managing and analyzing complex data sets while maintaining accuracy and consistency.

From a practical standpoint, managing and analyzing data in a networked computing environment offers various benefits. Standardizing the data and providing a structured view enables organizations to analyze data more easily and identify patterns, trends, and insights. Automating data management processes reduces the need for manual intervention, improving efficiency and reducing the risk of errors. Enabling data to be queried and analyzed in real time allows organizations to respond more quickly to changing market conditions and customer needs, improving their competitive advantage.

Another advantage is the ability to organize data coherently, using explicitly defined business language, which ensures seamless communication and understanding among decision-makers. The invention allows data to be made generally available in a governed manner across the domain, by serving as an interface for two unique personas to collaborate, eliminating limitations with respect to composability of data and inefficiencies with extract, and transform load (ETL). The declarative approach of writing models in a low-level format allows the abstraction of the data engineering or pre-configured files. This efficient separation of the logical tier of data from the physical tier allows a business data analyst to build on top of the logical tier without requesting changes on the physical tier every time. Data engineers can incorporate any needed changes without risking broken dashboards or the like.

The inventive approach of creating a logical data model first and then mapping it with the physical model eliminates the need to create multiple copies of data, which reduces the amount of storage required and can reduce the risk of data inconsistencies. Approaches described herein also reduce latency by allowing for the creation of dynamic data views tailored to the needs of different users, without the need to move or change the underlying source data. This eliminates the need to wait for data to be moved or transformed before it can be accessed, significantly reducing latency.

Various other functions and advantages are described and suggested below as may be provided in accordance with the various embodiments.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIGS. 1A and 1B illustrate an example environment in which aspects of the various embodiments can be implemented;

FIG. 2 illustrates an example block diagram of a data view system in accordance with an exemplary embodiment;

FIG. 3 illustrates an example of a network configuration for provisioning data pipelines to generate data views in accordance with various embodiments;

FIG. 4 illustrates an example architecture of a data view system in accordance with various embodiments;

FIG. 5 illustrates another architecture of the data view system in accordance with an embodiment;

FIG. 6 illustrates an example logical data model and physical data in accordance with various embodiments;

FIG. 7 illustrates an example process for generating data views in accordance with various embodiments;

FIG. 8 illustrates an example process for updating a dynamic data view in accordance with various embodiments;

FIG. 9 illustrates an example process for generating a customized data view in accordance with various embodiments;

FIG. 10 illustrates components of a computing device that supports an embodiment of the present invention;

FIG. 11 illustrates an exemplary architecture of a system that supports an embodiment of the present invention;

FIG. 12 illustrates another exemplary architecture of a system that supports an embodiment of the present invention; and

FIG. 13 illustrates components of a computer system that supports an embodiment of the present invention.

### DETAILED DESCRIPTION

Conceptual Architecture

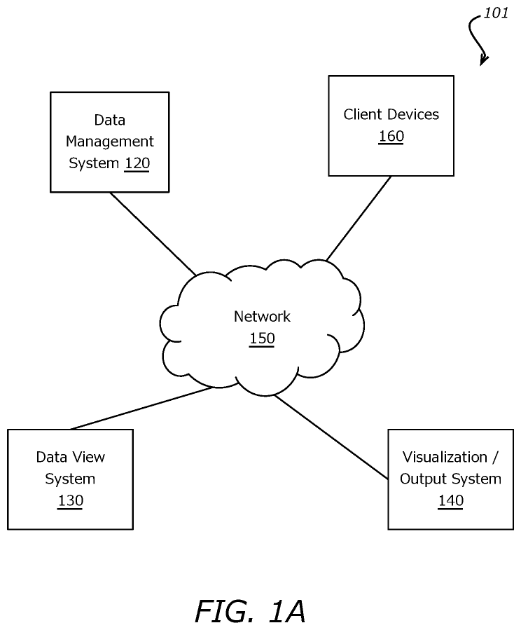

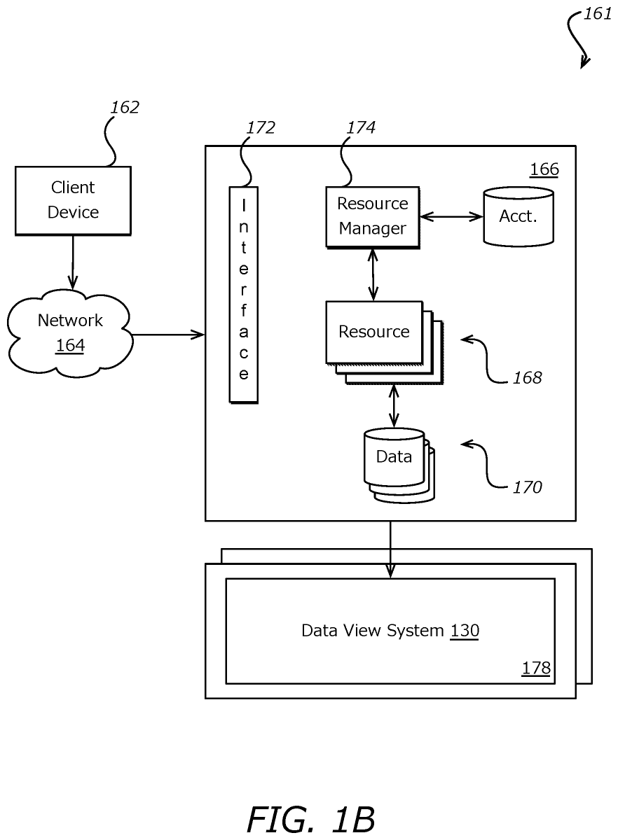

FIG. 1A illustrates an example environment 101 in which aspects of the various embodiments can be implemented. It should be understood that reference numbers are carried over between figures for similar components for purposes of simplicity of explanation, but such usage should not be construed as a limitation on the various embodiments unless otherwise stated.

As shown, the environment may comprise data management system 120, data view system 130, visualization/output system 140, and client devices 160. It should be known that the various systems and components described herein are exemplary and for illustration purposes only. The components may be reorganized or consolidated, as understood by a person of ordinary skill in the art, to perform the same tasks on one or more other servers or devices without departing from the scope of the invention. Other components may be used, as would be readily understood by a person of ordinary skill in the art, without departing from the scope of the embodiments described herein.

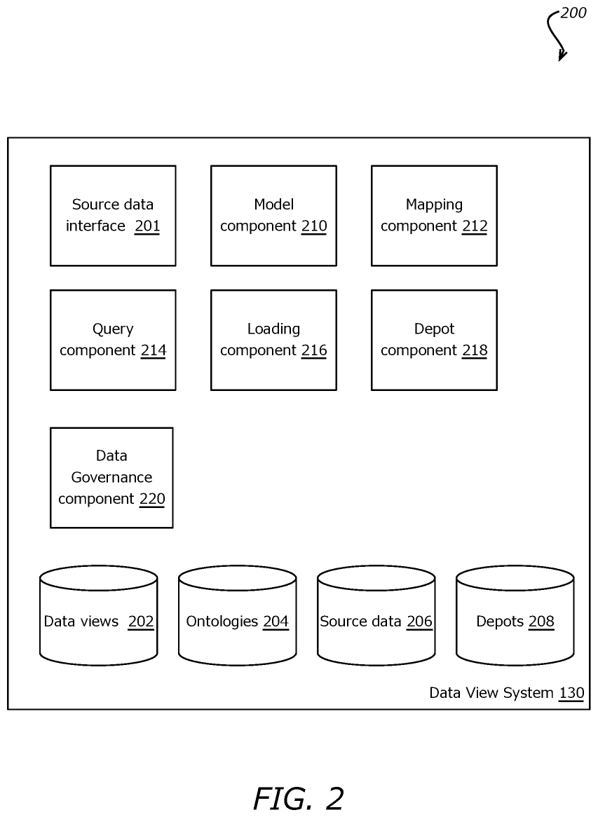

Data view system 130 is described in greater detail in FIG. 2 below, but in general, data view system 130 can generate one or more dynamic data views (also referred to as logical data models, logical models, logical conveyances, and the like). A dynamic data view allows users to visualize data or otherwise interact with data from a plurality of data resources (also referred to as physical data or source data) from various data stores across a domain (e.g., an enterprise, a unit within the enterprise, a company, etc.). In an example, a plurality of different dynamic data views (e.g., logical conveyances) can be derived from the same set of physical data, and directed to a plurality of different users for each user's needs. The plurality of different dynamic data views is derived without moving or changing the source data regardless of the format or how the source data is stored. In this way, a user can request a particular view of data. The system can source the data, resolve compliance issues, manage security, and access the data.

In certain embodiments, preconfigured data views can be generated, stored, and accessed when needed. The preconfigured data views can be generated by various vendors. In an embodiment, the preconfigured data views can be shared, purchased, rented, or otherwise obtained. In an example, the preconfigured data views can be purchased from a marketplace.

In an embodiment, a data view is based on one or more metrics. The data views can be updated when a metric is updated.

In an embodiment, a data view is a conveyance of an ontology. That is, a data view is a synthesized view of physical data into logical structures. In this way, a plurality of different logical conveyances of the same physical data per persona is possible without moving or changing the physical data. In an embodiment, an ontology is a formal representation of knowledge in a specific domain, it provides a common vocabulary, set of concepts, categories, and relationships that define the terms and concepts used to describe a particular subject or field, it helps in understanding and organizing information, concepts are the fundamental building blocks of an ontology, they are the terms or ideas that are used to describe a domain.

A domain is an area or subject of interest for which data is collected and managed. For example, a domain can refer to a specific business area, such as retail, healthcare, or finance; a particular field of study, such as physics, biology, or sociology; or a specific application, such as a website, a mobile app, or a software system.

Data management system 120 enables management techniques for data in one or more data stores. For example, data management system 120 can visualize data resources in databases across one or more domains. This can enable, for example, the ability to view which users are working with data, what they're doing with it, and how often the data is accessed, in a graphical user interface.

In an embodiment, data management system 120 can manage the data resources using a configurable set of directives. This allows for fine-grained control of governance, data enrichment, etc.

Data management system 120 can utilize a graphical user interface to manage the data resources.

Data management system 120 can execute database queries (e.g., SQL queries) on data resources, and provision data pipelines and workflows to, e.g., export reports. The data queries can be saved, shared, and modified by one or more users and results presented through one or more interfaces.

Data management system 120 operates on data in different formats. Data management system 120 includes a data ingestion component to ingest data. Data management system 120 can apply and store rich metadata, allowing users to view a complete data lineage, beginning with the original data source and including every process that has been run on it since it was ingested.

Data management system 120 manages data security and data governance. For example, data management system 120 can use a configurable set of tags and attributes to set granular permissions using column-level masking and row-level redaction. Data management system 120 can hash or mask the output of a data query to fit the permissions of an individual user making the query. In an embodiment, once an individual's permissions are set, data management system 120 can apply the permissions to subsequent queries.

Visualization/output system 140 is operable to process data, such as by presenting, storing, etc., obtained from one or more data views. In one embodiment, the system is used in a visualization system. The visualization system can take the data obtained from the data views and present it in a graphical format, such as a chart or graph. The visualization system can include various types of visualizations such as 2D and 3D plots, heatmaps, and more. Additionally, the visualization system can include interactive features, such as the ability to zoom, pan, and hover over data points to display additional information.

In another embodiment, the data can be used by one or more applications. For example, the data can be used to populate a dashboard for monitoring the performance of a business. The data can be used to create reports, alerts, and other types of notifications.

In yet another embodiment, the data can be stored for further processing. For example, the data can be stored in a data warehouse for later analysis. The data can be stored in a format that allows for efficient querying and analysis.

Client devices may include, generally, a computer or computing device including functionality for communicating (e.g., remotely) over network 150. Data may be collected from client devices, and data requests may be initiated from each client device. Client device(s) may be a server, a desktop computer, a laptop computer, personal digital assistant (PDA), a smart phone or other cellular or mobile phone, or mobile gaming device, among other suitable computing devices. Client devices may execute one or more client applications, such as a web browser (e.g., Microsoft Windows Internet Explorer, Mozilla Firefox, Apple Safari, Google Chrome, and Opera, etc.), or a dedicated application to submit data over network 150.

In particular embodiments, each client device may be an electronic device including hardware, software, or embedded logic components or a combination of two or more such components and capable of carrying out the appropriate functions implemented or supported by the client device. For example and without limitation, a client device may be a desktop computer system, a notebook computer system, a netbook computer system, a handheld electronic device, or a mobile telephone. The present disclosure contemplates any client device. A client device may enable a network user at the client device to access the network 150. A client device may enable its user to communicate with other users at other client devices.

A client device may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A client device may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the client device one or more Hyper Text Markup Language (HTML) files responsive to the HTTP request. The client device may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The client device may also include an application that is loaded onto the client device. The client device obtains data from the network 150 and displays it to the user within the application interface.

Exemplary client devices are illustrated in some of the subsequent figures provided herein. This disclosure contemplates any suitable number of client devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real-time or in batch mode one or more steps of one or more methods described or illustrated herein. One or more computing system may perform at different times or at different locations one or more steps of one or more methods described or illustrated herein, where appropriate.

Network 150 generally represents a network or collection of networks (such as the Internet or a corporate intranet, or a combination of both) over which the various components illustrated in FIG. 1A (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network or a combination of two or more such networks. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network or a combination of two or more such networks. The present disclosure contemplates any suitable network.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to clients devices or other devices in response to HTTP or other requests from clients devices or other devices. A mail server is generally capable of providing electronic mail services to various clients devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In a particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1A, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

FIG. 1B illustrates an example environment 161 in which aspects of the various embodiments can be implemented. It should be understood that reference numbers are carried over between figures for similar components for purposes of simplicity of explanation, but such usage should not be construed as a limitation on the various embodiments unless otherwise stated. In this example, a user can utilize a client device 162 to communicate across at least one network 164 to a multi-tenant resource provider environment 166. The client device 162 can include any appropriate electronic device operable to send and receive requests, messages, or other such information over an appropriate network and convey information back to a user of the device. Examples of such client devices include personal computers, tablet computers, smartphones, notebook computers, and the like.

The resource provider environment 166 can provide data management services for companies for various services. These services can include, for example, IT services, marketing services, payment services, technical support services, and human resource services, among other such services, products, and/or offerings.

The network(s) 164 can include any appropriate network, including an intranet, the Internet, a cellular network, a local area network (LAN), or any other such network or combination, and communication over the network can be enabled via wired and/or wireless connections.

The resource provider environment 166 can include any appropriate components for receiving requests and returning information or performing actions in response to those requests. As an example, the provider environment might include Web servers and/or application servers for receiving and processing requests, then returning data, Web pages, video, audio, or other such content or information in response to the request.

In various embodiments, the provider environment may include various types of resources that can be utilized by multiple users for a variety of different purposes. As used herein, computing and other electronic resources utilized in a network environment can be referred to as “network resources.” These can include, for example, servers, databases, load balancers, routers, and the like, which can perform tasks such as receiving, transmitting, and/or processing data and/or executable instructions. In at least some embodiments, all or a portion of a given resource or set of resources might be allocated to a particular user or allocated for a particular task, for at least a determined period of time. The sharing of these multi-tenant resources from a provider environment is often referred to as resource sharing, Web services, or “cloud computing,” among other such terms and depending upon the specific environment and/or implementation. In this example, the provider environment includes a plurality of resources 168 of one or more types. These types can include, for example, application servers operable to process instructions provided by a user or database servers operable to process data stored in one or more data stores 170 in response to a user request. As known for such purposes, the user can also reserve at least a portion of the data storage in a given data store. Methods for enabling a user to reserve various resources and resource instances are well known in the art, such that detailed description of the entire process, and explanation of all possible components, will not be discussed in detail herein.

In at least some embodiments, a user wanting to utilize a portion of the resources 168 can submit a request that is received to an interface layer 172 of resource provider environment 166. The interface layer can include application programming interfaces (APIs) or other exposed interfaces enabling a user to submit requests to the provider environment. The interface layer 172 in this example can also include other components as well, such as at least one Web server, routing components, load balancers, and the like. When a request to provision a resource is received to the interface layer 172, information for the request can be directed to a resource manager 174 or other such system, service, or component configured to manage user accounts and information, resource provisioning and usage, and other such aspects. A resource manager 174 receiving the request can perform tasks such as to authenticate an identity of the user submitting the request, as well as to determine whether that user has an existing account with the resource provider, where the account data may be stored in at least one data store 170 in the provider environment. A user can provide any of various types of credentials in order to authenticate an identity of the user to the provider. These credentials can include, for example, a username and password pair, biometric data, a digital signature, or other such information. The provider can validate this information against information stored for the user. If the user has an account with the appropriate permissions, status, etc., the resource manager can determine whether there are adequate resources available to suit the user's request, and if so can provision the resources or otherwise grant access to the corresponding portion of those resources for use by the user for an amount specified by the request. This amount can include, for example, capacity to process a single request or perform a single task, a specified period of time, or a recurring/renewable period, among other such values. If the user does not have a valid account with the provider, the user account does not enable access to the type of resources specified in the request, or another such reason is preventing the user from obtaining access to such resources, a communication can be sent to the user to enable the user to create or modify an account, or change the resources specified in the request, among other such options.

Once the user is authenticated, the account verified, and the resources allocated, the user can utilize the allocated resource(s) for the specified capacity, amount of data transfer, period of time, or other such value. In at least some embodiments, a user might provide a session token or other such credentials with subsequent requests in order to enable those requests to be processed on that user session. The user can receive a resource identifier, specific address, or other such information that can enable the client device 162 to communicate with an allocated resource without having to communicate with the resource manager 174, at least until such time as a relevant aspect of the user account changes, the user is no longer granted access to the resource, or another such aspect changes.

The resource manager 174 (or another such system or service) in this example can also function as a virtual layer of hardware and software components that handles control functions in addition to management actions, as may include provisioning, scaling, replication, etc. The resource manager can utilize dedicated APIs in the interface layer 172, where each API can be provided to receive requests for at least one specific action to be performed with respect to the data environment, such as to provision, scale, clone, or hibernate an instance. Upon receiving a request to one of the APIs, a Web services portion of the interface layer can parse or otherwise analyze the request to determine the steps or actions needed to act on or process the call. For example, a Web service call might be received that includes a request to create a data repository.

An interface layer 172 in at least one embodiment includes a scalable set of customer-facing servers that can provide the various APIs and return the appropriate responses based on the API specifications. The interface layer also can include at least one API service layer that in one embodiment consists of stateless, replicated servers which process the externally-facing customer APIs. The interface layer can be responsible for Web service front-end features such as authenticating customers based on credentials, authorizing the customer, throttling customer requests to the API servers, validating user input, and marshalling or unmarshalling requests and responses. The API layer also can be responsible for reading and writing database configuration data to/from the administration data store, in response to the API calls. In many embodiments, the Web services layer and/or API service layer will be the only externally visible component, or the only component that is visible to, and accessible by, customers of the control service. The servers of the Web services layer can be stateless and scaled horizontally as known in the art. API servers, as well as the persistent data store, can be spread across multiple data centers in a region, for example, such that the servers are resilient to single data center failures.

A host machine 178 in at least one embodiment can host data management system 120, data view system 130, and visualization/output system 140. It should be noted that although host machine 178 is shown outside the provider environment, in accordance with various embodiments, data management system 120, data view system 130, and visualization/output system 140 can both be included in provider environment 166, while in other embodiments, one or the other can be included in the provider environment. In various embodiments, one or more host machines can be instantiated to host such systems for third parties, additional processing of preview requests, and the like.

FIG. 2 illustrates example 200 of a data view system 130 in accordance with an exemplary embodiment. It should be understood that reference numbers are carried over between figures for similar components for purposes of simplicity of explanation, but such usage should not be construed as a limitation on the various embodiments unless otherwise stated. It should be further known that the various components described herein are exemplary and for illustration purposes only. In this example, the data view system 130 may comprise source data interface 201, model component 210, mapping component 212, query component 214, loading component 216, depot component 218, and data governance component 220. Data view system 130 may also include or be in communication with one or more data stores, including, for example, data views data store 202, ontologies data store 204, source data store 206, and depot data store 208.

It should be noted that although the data stores are shown as separate data stores, data from the data stores can be maintained across fewer or additional data stores. The data stores can be accessed by each of the various components in order to perform the functionality of the corresponding component. Other components, systems, services, etc. may access the data stores. Although data view system 130 is shown as a single system, the system may be hosted on multiple server computers and/or distributed across multiple systems. Additionally, the components may be performed by any number of different computers and/or systems. Thus, the components may be separated into multiple services and/or over multiple disparate systems to perform the functionality described herein.

Source data interface 201 obtains the source data (e.g., “physical data”, dataset, data objects, etc.) maintained in source data store 206. In an example, in the retail industry, source data may include data relating to purchase transactions, customer data for each order, store locations, etc., that have been collected from various sources, such as data resources which collect consumer data, retail order data, etc.

As described herein, source data interface 201 may include a data interface and service interface configured to periodically receive documents, requests, and/or any other relevant information to facilitate data views. In an example, a database server or other appropriate component is generally capable of providing an interface for managing data stored in one or more data stores. In an embodiment, source data interface 201 can include any appropriate components known or used to receive requests or other data from across a network, such as may include one or more application programming interfaces (APIs) or other such interfaces for receiving such requests and/or data, including but not limited to, data scrapes, API access, etc. In a specific example, source data interface 201 communicates with the computing device(s), or other repositories or devices to obtain and store source data.

Data views may be stored in data views data store 202. In an embodiment, a data view can be a conveyance of a concept (e.g., an ontology). A data view may enable a persona to see data from various locations (e.g., various data sources), translated to business-friendly language, through a single lens (e.g., single, bespoke view). Data views may include a user interface appropriate for a particular ontology (e.g., appropriate for an industry, enterprise, etc.) through which to present the data.

Ontologies may be stored in ontologies data store 204. Ontologies can be industry-specific. For example, in the environmental industry, a business can require environmental safety guidelines (ESG), which have specific metrics that a company should be measuring, key performance indicators (KPI), and other metrics to measure compliance, company growth, sustainability, etc. Ontologies for the environmental industry can include data relating to these types of metrics.

Source data (e.g., “physical data”, dataset, data objects, etc.) may be stored in source data store 206. For example, for a database, such as a Postgres database, source data may include tables within the database. In another example, in the retail industry, physical data may include data relating to purchase transactions, customer data for each order, store locations, etc., that have been collected from various sources, such as data resources that collect consumer data, retail order data, etc.

In an embodiment, a depot may be an abstraction of common source systems (e.g., source data systems). For example, a depot can include a data system abstraction wrapper around a data system. In an embodiment, a data system comprises physical data, including, e.g., tables for the physical data or data set. A table for the data set can be associated with a relation schema. In an embodiment, a table is a structure with a plurality of rows (aka “tuples”), each of which has the attributes defined by the relation schema. Tables might also be associated with indexes to aid in looking up values on certain columns. A relation schema comprises the logical definition of the table. For example, the relation schema defines the name of the table, the name, and type of each column in the table, etc. A database schema comprises the collection of relation schemas for a database. A database is, formally, any collection of data. In this context, the database would be a collection of tables. A DBMS (Database Management System) is the software (like MySQL, SQL Server, Oracle, etc) that manages and runs a database.

A depot allows a user to query any data source (e.g., database, data lake, blob storage, files, etc.) like a flat table, without needing to create a data pipeline to first ingest their data and transform it to a queryable format. Depots can be stored in depot data store 208.

Model component 210 is operable to define a logical data model (representing a logical view). Model component 210 is operable to create a description of a domain using its particular concepts. In an embodiment, model component 210 curates the knowledge (e.g., ontology) and logical data model, for example, by enabling the creation of a model of information in a domain friendly language. In an embodiment, model component 210 defines the properties of datasets and relationships between the datasets required for a particular data view and/or a particular industry (which uses, or “activates”, the datasets). To use data as an asset, an organization must be able to create a business ontology with a harmonized logical data model of its data. The approach would entail mapping the logical data model to the physical data model pointing at the appropriate data sources. This would mean business users can freely explore data in a business-friendly language without data engineering effort. Takes the requirements of a data view (e.g., the data view requested by a user, such as a business user), and designs a logical data model that contains information such as schema of entities, primary-keys, foreign-keys, and cardinality between tables (one-to-many, many-to-one, many-to-many).

Mapping component 212 is operable to map the logical data model to one or more data sources. In an embodiment, mapping component 212 includes definitions for logics for metrics. In an embodiment, mapping component 212 writes the logical data model. In certain embodiments, mapping component 212 may utilize a synth (also referred to as synthesized layer), which can include a mapping layer overlaid on top of the data resources and/or depots within the data fabric. The synth can collect a plurality of source data (e.g., physical data) appropriate for a particular ontology and synthesize the source data into a logical view. The synth may include utilizing data pipelines to extract source data, manipulate the data, transform it, and load it elsewhere, for example, in a logical view.

Query component 214 is operable to query the logical data model (representing the logical view). For example, a business user can query the model, using Model Query Language (MQL). Query component can convert queries MQL (e.g., queries written in a domain friendly language) into SQL queries that can be run on top of datasets to fetch results.

For example, a business user could use the query component 214 to retrieve data from multiple datasets, such as sales data and customer data, to generate a report on customer purchasing behavior. The user could use MQL to write a simple query, such as “Show me the total sales by customer for the past year,” which would be converted into a SQL query by the query component 214 and executed on the underlying datasets to fetch the desired results.

In accordance with an embodiment, query component 214 may support other domain-specific languages or query interfaces that are tailored to the needs of specific users or business units. For example, the query component 214 may support a natural language interface that allows users to ask questions in plain English or a graphical user interface that allows users to build queries by dragging and dropping data elements.

In an embodiment, query component 214 may support various data visualization techniques to help users understand and analyze the data. For example, query component 214 may support the creation of charts, graphs, and other visualizations that allow users to quickly identify trends and patterns in the data.

Loading component 216 is operable to mitigate latency issues. Loading component 216 may be implemented as a software module or hardware component that is designed to optimize the data-loading process. In an embodiment, loading component 216 may include features that help to improve data throughput and reduce data latency. For example, it may utilize caching or buffering techniques to store data in memory for faster access. It may also use compression algorithms to reduce the size of the data being loaded, thereby reducing network bandwidth requirements and improving overall performance. In an embodiment, loading component 216 may be integrated with the mapping component 212 to ensure that data is loaded correctly and efficiently. The mapping component 212 performs the mapping of the logical data model to the physical data model, and the loading component 216 ensures that the mapping process is executed smoothly during the loading of data onto the proprietary data management platform or database. This may involve making adjustments to the mapping steps to ensure that the data is properly structured and optimized for loading onto the platform.

For example, if the mapping component 212 encounters a data source with inconsistent or poorly defined data structures, it may need to modify the mapping logic to properly handle the data. This could involve creating additional mapping steps to transform the data into a more consistent format or making adjustments to the existing mapping steps to account for the inconsistencies.

In addition, the mapping component 212 may need to optimize the mapping steps to ensure that the data is loaded onto the platform in the most efficient way possible. This could involve making changes to the mapping steps to reduce the amount of data being loaded, optimizing the data pipeline to improve data throughput, or applying compression or other techniques to reduce the size of the data being loaded.

Depot component 218 is operable to abstract source data systems to create depots. In an embodiment, a depot is a data system abstraction wrapper around a data system. For example, in a database, such as a Postgres database, the database includes tables, which includes fields. The tables and fields comprise the source data (e.g., physical data or data set). Depot component 218 may abstract the tables and fields in a layer above the source data within the data fabric.

Data governance component 220 is operable to ensure governance works across every access point. In an embodiment, Attributes Based Access Control (ABAC) can be utilized, and a tagging system is extensively leveraged to enable governance compliance across every access point.

Data governance component 220 may ensure that, within a persona (e.g., an organization, enterprise, etc.), high data quality exists throughout the complete lifecycle of the data, and data controls are implemented that support the persona's objectives (e.g., business objectives). For example, data governance component 220 may ensure availability, usability, consistency, data integrity, and data security. Data governance component 220 may also ensure effective data management throughout an enterprise, such as accountability for the adverse effects of poor data quality and ensuring that the data that an enterprise has can be used by the entire organization.

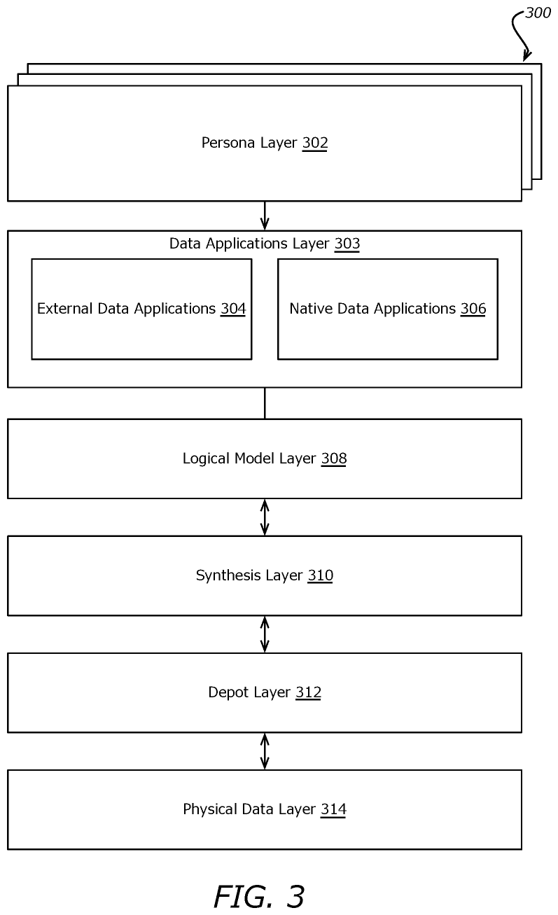

FIG. 3 illustrates an example 300 of the configuration for provisioning data pipelines to generate data views in accordance with various embodiments. In an embodiment, a data pipeline is a set of processes that extract, transform, and load data from various sources into a destination storage or system, usually with a specific business objective in mind. The pipeline can involve data ingestion, data transformation, data integration, data validation, data loading, and data storage. The process can start with identifying data sources, mapping data elements to a logical model, transforming data elements, and finally loading the data into a target system or storage. In an embodiment, provisioning a data pipeline can refer to the process of setting up the data pipeline and making it available for use by authorized users. This can involve configuring access controls, defining data sources, specifying the mapping logic, and determining how the data is processed and loaded. In a specific embodiment, provisioning a data pipeline comprises setting up a mapping layer between the logical data model and the physical data sources (e.g., depots). This can involve defining the logic for metrics, writing the logical data model, and using a synthesized layer (synth) to collect and synthesize source data appropriate for a particular ontology into a logical view. The synth may also utilize data pipelines to extract, manipulate, transform, and load data into the logical view. By provisioning the mapping component, authorized users can query the logical data model using Model Query Language (MQL) and the query component can convert those queries into SQL queries that can be run on top of the datasets to fetch results.

As illustrated in FIG. 3, multiple computing systems are operable to execute various programs, applications, and/or services, and are further operable to access reliable block-based data storage, such as under the control of a block-based data storage service. In particular, an example of provisioning data pipelines can comprise provisioning a persona layer 302, a data applications layer 303, a logical data model layer 308, a synthesis layer 310, a depot layer 312, and physical data (e.g., source data) layer 314.

In an embodiment, persona layer 302 may include various users who conventionally would have different data requirements and access within an enterprise or business due to data governance policies, such as business users, data analysts, data scientists, data engineers, and so forth. Logical views may differ between personas due to differences in requirements for dataset relations, data quality, etc.

In an embodiment, data applications layer 303 comprises data applications. In an example, data applications layer 303 comprises external data application 304 and native data application(s) 306. Data applications may visualize data based on a particular ontology and/or a particular request to access and activate specific data from the source data systems. In an embodiment, data applications may query the lens layer, for example, using a lens query language (LQL), model query language (MQL), etc.

In an embodiment, logical data model layer 308 may define logical data models which represent a particular schema required for a particular ontology. The ontology may correspond to the industry or enterprise or data requirements of the persona layer.

In an embodiment, synthesis layer 310 can map the physical data to a logical data model (which conveys a logical view). Physical data from various sources are typically not in a common form, as each company that collects and manages data does so in its own way. For example, some companies use systems, applications, and products (SAP) for enterprise resource planning (ERP), some companies use Microsoft Dynamics, other companies use Oracle, and so forth. As such, for a persona that utilizes those ERPs, the synthesis layer can build a synth (e.g., synthesize data into a common form) for that specific system, such as by mapping the physical data with the logical data model, such that all relevant data from the various sources are conveyed in a single logical view (e.g., data view) for the persona. The synthesis layer may be configured to meet the requirements of preconfigured files corresponding to a schema of a particular logical data model.

In an embodiment, a depot layer 312 can create an abstraction of the source systems. The depots allow a user (e.g., a persona) to query any source system like a flat table without requiring the creation of a data pipeline to first ingest the source data and transform it into a queryable format.

In an embodiment, a physical data layer 314 may include source data from various source systems (e.g., databases, data lakes, blob storage, files, and the like). Each source may be isolated from one another, and may be managed and accessible by dedicated enterprise data management systems or other internal data management systems.

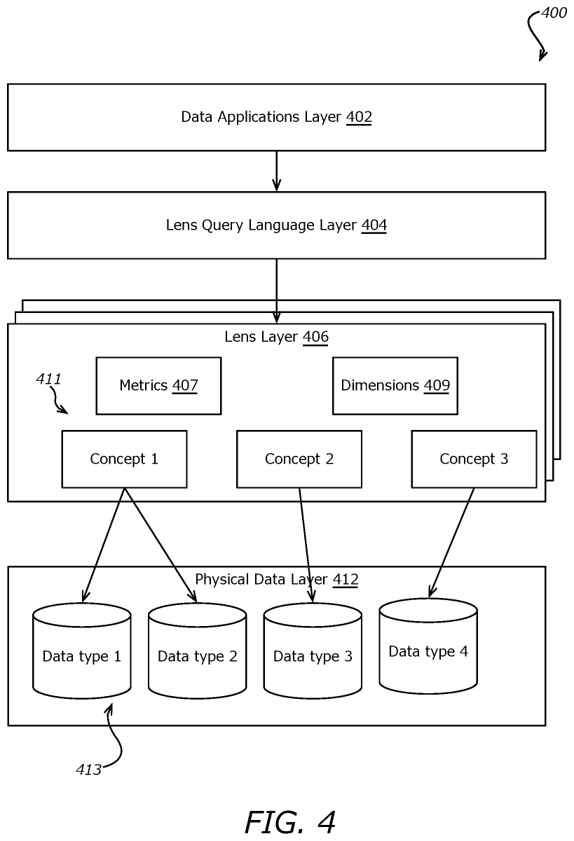

FIG. 4 illustrates an example 400 architecture of a data view system in accordance with various embodiments. As described, a data view system is operable to generate one or more dynamic data views (also referred to as logical data models, logical models, logical conveyances, and the like). In this example, the architecture of the data view system can comprise a data applications layer 402, a lens query language layer 404, a lens layer 406 (also referred to as a logical data model layer), and a physical data layer 412.

In an embodiment, the data applications layer 402 comprises data applications, such as external data applications and native data applications. Data applications may visualize data based on a particular ontology and/or a particular request to access and activate specific data from the source data systems.

Data applications may query the lens layer 406, for example, using a lens query language (LQL), model query language (MQL), etc., associated with the lens query language layer 404. n an embodiment, the lens query language layer 404 is a component that facilitates querying of the lens layer 406. The lens query language layer 404 provides an interface for data applications to query the lens layer 406, using a lens query language (LQL) or other query languages such as model query language (MQL) etc. LQL is a language that is designed specifically to query the logical data model defined by the lens layer 406, whereas MQL is a language that is designed specifically to query the physical data model.

The lens query language layer 404 enables data applications to retrieve data from the lens layer 406 in a structured and efficient manner, by providing a set of predefined commands or functions that can be used to query the lens layer 406. These commands or functions can be used to retrieve data from specific entities, filter data based on certain criteria, join data from different entities, and perform other types of queries.

In an embodiment, the lens query language layer 404 can also provide a set of security and access controls to ensure that data is only retrieved by authorized users and applications, and that the data is protected from unauthorized access. This layer act as a gatekeeper to the lens layer and can be used for data governance and compliance reasons.

In an embodiment, the lens layer 406 is operable to define a logical data model, represented by a logical view (also referred to as data view). A logical data model comprises information such as schema of entities, primary-keys, foreign-keys, and cardinality between tables.

A logical view or a data view is a conveyance of an ontology. Lens layer 406 may determine or otherwise define the requirements of an ontology (e.g., as required by business users, data engineers, etc.). For example, in the context of a logical data model, wherein a logical data model is represented by a logical view or data view, an ontology can be used to define the concepts (e.g., concepts 411), categories, and relationships that are used to describe the data.

Concepts can represent components of an ontology. In an embodiment, concepts can define a domain. In an embodiment, concepts can be organized into a hierarchy, with more general concepts at the top and more specific concepts at the bottom. The concepts in an ontology can be connected by relationships, which describe how the concepts are related to each other.

A domain can refer to the area or subject of interest for which data is collected and managed. For example, a domain can refer to a specific business area, such as retail, healthcare, or finance; a particular field of study, such as physics, biology, or sociology; or a specific application, such as a website, a mobile app, or a software system. In certain embodiments, a domain can also refer to the scope or range of possible values of a specific attribute or variable. For example, a domain can be defined as the set of all possible values for a variable such as “age,” “income,” or “temperature.” In this context, the domain defines the constraints on the values that can be assigned to the variable.

An ontology provides a common understanding of the data and its meaning, which can be used to ensure consistency and accuracy in the data. For example, an ontology for a retail business might define concepts such as “customer,” “product,” “order,” and “invoice,” and the relationships between them. Stated simply, an ontology is a formal representation of knowledge in a specific domain or area of study. It is a system of concepts, categories, and relationships that defines the terms and concepts used to describe a particular subject or field. In accordance with various embodiments, ontologies provide a common vocabulary and set of rules for understanding and organizing information within a particular domain.

A logical view or data view can be based on metric(s) 407 and dimension(s) 409. In an embodiment, a metric is specific information that a company is measuring and can be used to optimize for a particular output. They are used to track progress towards goals, identify areas for improvement, and make data-driven decisions. Metrics can be used in a variety of fields including business, finance, manufacturing, marketing, and more. Examples of metrics include website traffic, sales revenue, customer satisfaction, and employee productivity. Metrics can be tracked over time to monitor progress and identify trends. In an embodiment, a logical view or data view can be updated when a metric is updated.

A dimension is an attribute or characteristic used to describe a metric. Dimensions can be used to provide context or additional information about a metric. They are used to segment or group data, and can be used to drill down into specific subsets of data. Common examples of dimensions include time, location, product category, and customer demographics. For example, in a business context, revenue is a metric that can be broken down by dimensions such as time (year, quarter, month), location (region, country, city), product category (product line, product type), and customer demographics (age, gender, income). This allows a business to understand revenue trends and performance across different segments of the data.

In an embodiment, the physical data layer can comprise source data 413 from various source data systems. The source data systems may be isolated from each other. In an embodiment, physical data layer 412 can represent the lowest level of the data architecture that represents how the data is stored and accessed in a specific technology or database management system (DBMS). It is the implementation of the logical data model in a specific technology, such as a relational database, a NoSQL database, or a file system. In an embodiment, physical data layer 412 is operable to facilitate storage and retrieval of the data. It includes the specific tables, columns, indexes, and other structures that are used to store and access the data. Physical data layer 412 also includes the specific SQL or other query language that is used to access the data.

In an embodiment, a logical data model can be used to create the physical data model, which is a representation of the data and relationships in a specific database management system (DBMS) or data storage technology. For example, as described, a logical data model represents the data and relationships that are required by an organization or system, and is independent of any specific technology or implementation, and the physical data model is a representation of the data and relationships in a specific database management system (DBMS) or data storage technology. In an embodiment, to create a physical data model from a logical data model, the logical data model is mapped to the specific structures and capabilities of the chosen DBMS or data storage technology. This process involves translating the entities, attributes, and relationships defined in the logical data model into tables, columns, indexes, and other structures that are specific to the chosen technology. For example, a one-to-many relationship in the logical data model would be represented as a foreign key in the physical data model. In a specific example, a logical data model for a retail business that defines the entities “customer,” “product,” “order,” and “invoice,” and the relationships between them. To create a physical data model, the entities and relationships defined in the logical data model would be mapped to tables and columns in a relational database management system (RDBMS) such as MySQL or PostgreSQL. For example, the “customer” entity would be mapped to a “customers” table, which would have columns such as “customer_id,” “name,” “address,” and “email.” The “order” entity would be mapped to an “orders” table, which would have columns such as “order_id,” “customer_id,” “product_id,” and “quantity.” The relationship between the “customer” and “order” entities would be represented as a foreign key in the “orders” table, linking the “customer_id” column to the “customer_id” column in the “customers” table.

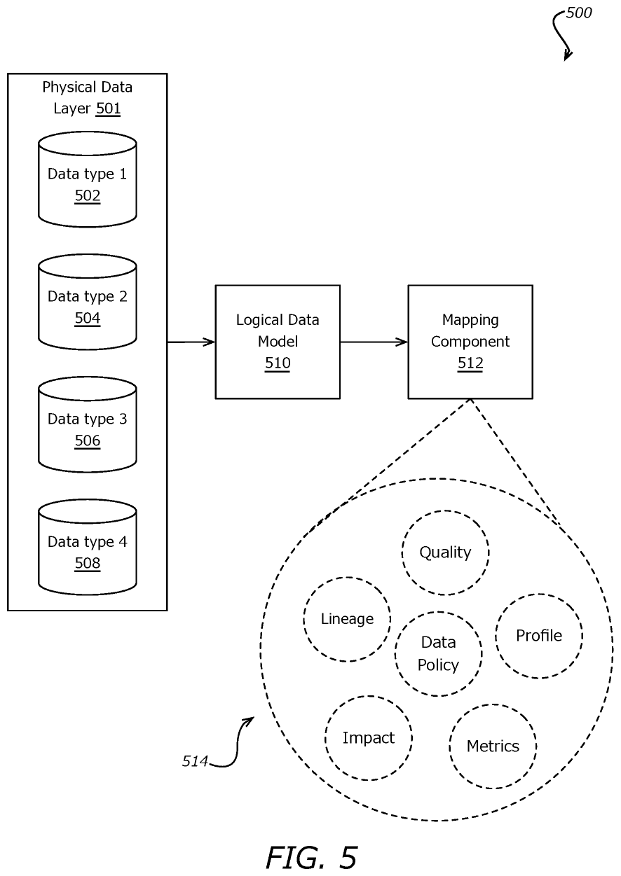

FIG. 5 illustrates example 500 of an architecture of the data view system in accordance with an alternate embodiment. In an embodiment, physical data layer 501 comprises physical data 502, physical data 504, physical data 506 and physical data 508.

In an embodiment, the physical data (also referred to as source data) can stored and managed in various source data systems and be associated with different data types. In an embodiment, the source data systems may be isolated from each other. For example, physical data 502 may be numerical data, such as customer ages, which can be stored in a first source data system. Physical data 504 may be text data, such as customer names, which can be stored in a second source data system. Physical data 506 may be date data, such as order dates, which can be stored in a third source data system. Physical data 508 may be Boolean data, such as whether a customer is subscribed to a newsletter, which can be stored in a fourth source data system. The physical data layer 501 provides a method for securely and reliably managing and accessing the physical data stored in the various source data systems, while maintaining the integrity of the data.

In a specific example, a retail business requires an ontology that is a business ontology. As described, an ontology creates a description of a domain using its particular concepts. Specifically, the business ontology is a description of the retail business domain. The business ontology may require a particular dataset and entity relationships within the dataset, a particular data quality, etc., for example, customer identity, date of a purchase transaction, amount of the transaction, name and location of a store, and so forth. The physical data may include a plurality of data objects including such attributes, but the data objects may be disconnected from each other, be managed under different formats, etc., as they are managed by various isolated data source systems.

In an embodiment, depots may create abstractions of each source data system. A depot may serve as an intermediary layer between the physical data layer and the application layer, where it abstracts the complexity of the underlying data sources and provides a simplified and consistent interface for the application layer to access and manage the data. The depot creates abstractions of each source data system, by providing a consistent set of entities, attributes, and relationships that are independent of the specific data storage technology or database management system (DBMS) used in each source data system. This allows the application layer to access and manage the data in a consistent way, regardless of the underlying data storage technology or DBMS. For example, the depot may create an abstraction of a source data system that uses a relational database management system (RDBMS) and another abstraction for a source data system that uses a NoSQL database. This allows the application layer to access and manage the data in a consistent way, regardless of the underlying data storage technology or DBMS.

Logical data model 510 may utilize the ontology to create a model of information in a domain friendly language. The logical data model may ensure governance works across every access point, for example, by utilizing attributes-based access control (ABAC) and extensively leveraging a tagging system that enables governance compliance across every access point. The logical data model contains information such as schema of entities, primary-keys, foreign-keys and cardinality between tables (one-to-many, many-to-one, many-to-many) appropriate for a particular ontology. The common semantic model may also define logics for business metrics and calculated columns.

Mapping component 512 can map logical data model 510 to the depots corresponding to the various source data systems, such that a user is able to query any source data system, through the logical data model. In an embodiment, mapping component 512 takes into account various factors 514, such as lineage, quality, data policy, profile, and impact metrics, to ensure that the logical data model 510 accurately represents the data in the underlying source data systems.

Lineage can refer to the origin and history of the data. The mapping component 512 maps the lineage of the data in the logical data model 510 to the corresponding data in the source data systems, to ensure that the data is accurate and can be traced back to its source.

Quality can refer to the accuracy and completeness of the data. The mapping component 512 maps the quality requirements of the data in the logical data model 510 to the corresponding data in the source data systems, to ensure that the data is of high quality and can be trusted.

Data policy can refer to the rules and regulations that govern the handling of the data. The mapping component 512 maps the data policy requirements of the data in the logical data model 510 to the corresponding data in the source data systems, to ensure that the data is handled in compliance with the appropriate rules and regulations.

Profile can refer to the characteristics of the data, such as its structure, format, and content. The mapping component 512 maps the profile of the data in the logical data model 510 to the corresponding data in the source data systems, to ensure that the data is in the appropriate format and structure for the logical data model 510.

Impact metrics can refer to the performance and scalability of the data. The mapping component 512 maps the impact metrics of the data in the logical data model 510 to the corresponding data in the source data systems, to ensure that the data can be accessed and managed in an efficient and scalable way.

The mapping component 512 also considers fingerprint and metrics in the mapping process. In an embodiment, a fingerprint is a unique identifier for each data set and metrics are used to measure the performance of the data. Business context mapping maps these data requirements to the depots accordingly.

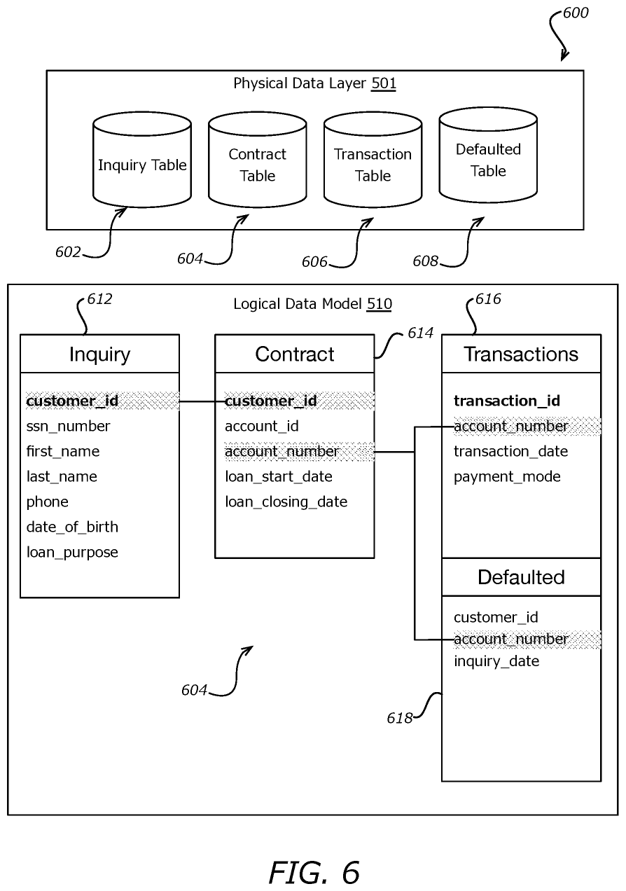

FIG. 6 illustrates an example 600 of a logical data model and a physical data layer in accordance with various embodiments. In this example, physical data layer 501 comprises a physical data model. A physical data model represents the actual structure of the data in a database or data store. It can define the specific data types, formats, and relationships between the data elements in the system. Different types of data, such as text, numbers, dates, and binary data, can be associated with different data types. As shown in FIG. 6, physical data layer 501 represents the physical data model, which includes data from various data stores, such as inquiry table data store 602 which stores physical data associated with inquiry entity 612, contract table data store 604 which stores physical data associated with contract entity 614, transaction table data store 606 which stores physical data associated with transactions entity 616, and defaulted table data store 608 which stores physical data associated with defaulted entity 618. The physical data can be stored in different source data systems, such as databases or data lakes.

In an embodiment, each entity in logical data model 510 is mapped to the appropriate data sources in the physical data layer 501 by pointing at the appropriate data sources using attributes such as customer_id, account_number, etc. For example, inquiry entity 612 comprises attributes such as customer_id, ssn_number, first_name, last_name, phone, date_of_birth, loan_purpose, and is mapped to contract entity 614 via the customer_id attribute. Transactions entity 616 comprises attributes such as transaction_id, account_number, transaction_date, payment_mode and is mapped to contract entity 614 via the account_number attribute. Defaulted entity 618 comprises attributes such as customer_id, account_number, and inquiry_date, and is mapped to contract entity 614 via the account_number attribute.

Accordingly, in accordance with various embodiments, approaches provides a technical solution for improving data management and analysis by utilizing a mapping process that structures and optimizes data for loading onto a platform. The mapping process effectively identifies relationships between entities and attributes within the data, allowing for meaningful insights to be extracted and informed decisions to be made. The technical advantage of the mapping process is that it mitigates latency issues and provides an optimized data structure, resulting in improved data analysis capabilities.

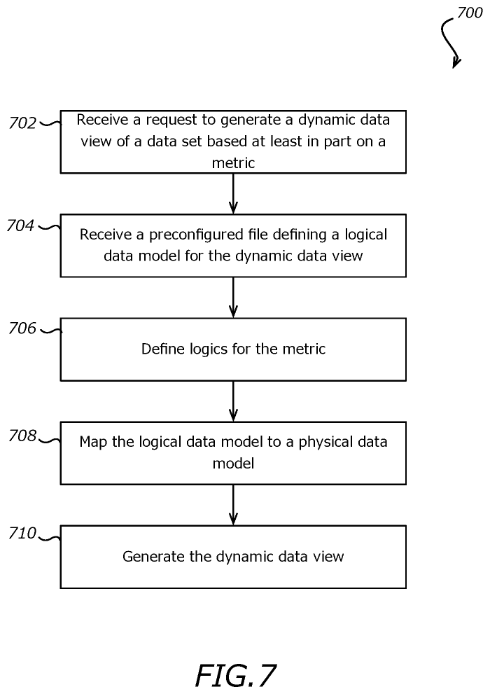

FIG. 7 illustrates an example process 700 for creating data views in accordance with various embodiments. In embodiments, the method steps or techniques depicted and described herein can be performed in a processor comprising one or more of the data management system 120, data view system 130, and visualization/output system 140 in FIG. 2, the method steps being encoded as processor-executable instructions in a non-transitory memory of one or more computing devices. The techniques of FIG. 7 may be implemented in an operating system kernel, in a separate user process, in a library package bound into network applications, on a specially constructed machine, on an application-specific integrated circuit (ASIC), or a field programmable gate array (FPGA). The process may comprise additional steps, fewer steps, and/or a different order of steps without departing from the scope of the invention as would be apparent to one of ordinary skill in the art.

Step 702 comprises receiving a request to generate a dynamic data view of a data set based at least in part on a metric. The request may be initiated by a user, such as a business user or data analyst, who wants to analyze data trends or patterns. The request can be received, for example, by a data view layer, which can be part of the data management system 120. The request can be defined using a data view query language, such as Model Query Language (MQL) or Lens Query Language (LQL).

In accordance with various embodiments, the data set is maintained across a plurality of data stores connected via a network. In various embodiments, the data set is stored in a non-standardized format and not correlated. Non-standardized format can refer to the fact that the data stored in the various data stores is not organized or formatted in a consistent manner. This can make it difficult for users to understand or analyze the data as different data stores may have different structures or formats. Not correlated can refer to the fact that the data in the various data stores is not related to each other in a meaningful way. This can make it difficult for users to see patterns or connections between the data as it is not organized into a logical structure. For example, a data set may have customer information stored in a MySQL database and sales information stored in a MongoDB database. The customer information may have fields such as “name”, “address”, and “phone number”, while the sales information may have fields such as “product”, “quantity”, and “date”. The data in these two databases is not correlated in any meaningful way as it is difficult to understand how the customer information relates to the sales information without additional processing.

Step 704 comprises receiving a preconfigured file defining a logical data model for the dynamic data view. The logical data model is a conceptual representation of the data and defines how the data is related to each other. In an embodiment, the preconfigured file may comprise a schema for the logical data model, including entities, primary keys, foreign keys, or cardinality between tables.

Step 706 comprises defining logics for the metric. In an embodiment, defining logics comprises defining an ontology based on entities including, for example, measures and dimensions. For example, an appropriate metric(s) is determined and defined for a particular ontology. The ontology is completed by filling relationships between entities. The workflow harmonizes the ontology into a logical data model. For example, the workflow evaluates data quality by determining whether an ontology is missing/empty data (e.g., data objects, data fields, etc.) from its corresponding logical data model. In an embodiment, an empty data field is a field in the data set that does not contain any data. This can happen for various reasons, such as missing or corrupted data, a data source that has not yet been populated, or a problem with the data pipeline. By determining empty data fields, the system can identify areas where data is missing or incomplete. This information can be used to improve the quality of the data set and to avoid any incorrect conclusions or analyses based on incomplete data. The system can also use this information to refine the ontology and to make adjustments to the data pipelines to ensure that all required data is being captured. Once empty data fields have been identified, the system can take appropriate action to correct the problem. This may involve re-running data pipelines to capture missing data, contacting data sources to ensure that data is being provided correctly, or updating the ontology to exclude data fields that are not relevant to the analysis.

Step 708 comprises mapping the logical data model to a physical data model to generate standardized data. In certain embodiments, this can include preprocessing the data to clean, transform, and map it to a common format. Correlating to the logical data model includes joining, grouping, and summarizing the data so that it can be easily understood and analyzed. For example, a data set may have customer information stored in a MySQL database and sales information stored in a MongoDB database. The logical data model may define that customer information should be related to sales information by the customer's ID. The standardized data is generated such that the data set is correlated to the logical data model for the dynamic data view. In an embodiment to generate standardized data, the system could extract the customer information and sales information from the respective databases, and then join the two data sets on the customer's ID. This would create a new data set that has the customer information and sales information related to each other by the customer's ID. The physical data model is associated with the plurality of data stores, and the mapping may be done according to a preconfigured file (configuration file) for the particular logical data model (e.g., for a particular schema of the logical data model). The configuration file may define the entities in a schema using SQL queries. The configuration file may be generated by a user or may be generated by a machine which learns from a training model. The workflow can allow a user to query the logical data model, for example, using an SQL derivative query language such as Model Query Language (MQL), Lens Query Language (LQL), and the like. In an embodiment, mapping may include mapping the data in the data set to the fields in the logical data model. This can include identifying the fields in the data set that correspond to the fields in the logical data model and ensuring that the data in these fields is consistent with the data model.

Step 710 comprises generating the dynamic data view. The dynamic data view provides a structured view of a data set that is maintained across a plurality of data stores. The dynamic data view allows users to visualize the data set or otherwise interact with the data set. The dynamic data view is derived without moving or changing the data set, and regardless of the format or how the data set is stored.

In certain embodiments, a dynamic data view is generated based on a third-party dataset, thereby expanding the scope of datasets that can be used to generate the data view. The generated data view can then be transmitted to various users to enable them to interact with the data and derive insights from it. In an embodiment, obtaining a third-party data schema refers to the process of acquiring a schema or metadata that describes the structure of a dataset from a third-party source, such as an external organization or data provider. The third-party schema can include information about entities, attributes, relationships, and other metadata that define the structure of the dataset. In an embodiment, generating the dynamic data view based on the third-party data schema comprises mapping the logical data model defined in the preconfigured file to the third-party schema. This mapping process can include identifying the entities and attributes in the third-party schema that correspond to the entities and attributes in the logical data model and mapping them accordingly. Once the mapping is completed, standardized data can be generated from the third-party dataset that is correlated to the logical data model, similar to the mapping process described earlier.

In an embodiment, transmitting data based on the dynamic data view comprises sending the generated data view to a target audience. This can include various means of transmitting data, such as streaming, publishing, sharing via APIs, or other mechanisms, to allow users to access the data view and interact with it. The data view can be used by various parties, such as analysts, data scientists, business users, or other stakeholders, to gain insights, make decisions, or take actions based on the data view.

In certain embodiments, a dynamic data view can be made available for sale or rent to interested parties. The dynamic data view may be hosted on a server or may be distributed as a file that can be imported into a data visualization application. The process of providing the dynamic data view for purchase or rent can involve establishing a marketplace or storefront where users can browse available data views and select the one that best meets their needs. The marketplace may include various categories of data views, such as views for specific industries or use cases, as well as different pricing tiers based on the complexity and level of detail of the view. To enable the sale or rental of the dynamic data view, the system may include a licensing mechanism to ensure that users are authorized to access the data view. The licensing mechanism may involve implementing a paywall or requiring users to purchase a license key to unlock access to the view. Additionally, the system may include measures to protect the intellectual property of the view, such as encryption or digital rights management (DRM) technology. In an embodiment, the process of providing the dynamic data view for purchase or rent may also include offering customization services to users. For example, a user may purchase a base data view and then request additional features or modifications to better suit their specific needs. The system may provide tools for users to make these customizations themselves or offer professional services to make the modifications on behalf of the user.

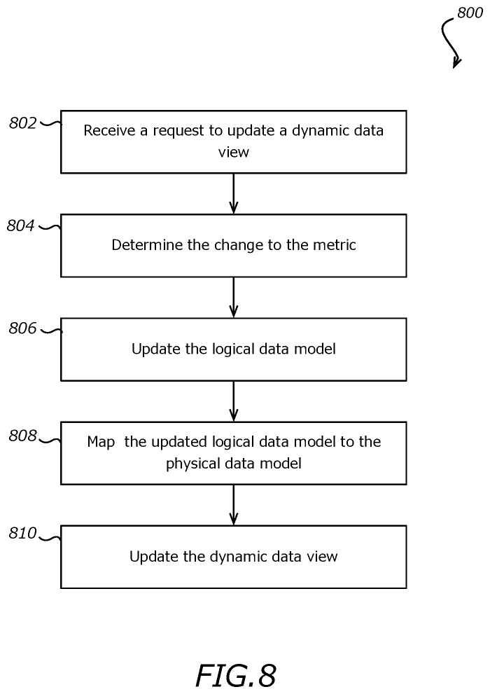

FIG. 8 illustrates an example process 800 for updating a dynamic data view in accordance with various embodiments. In accordance with an embodiment, in the situation a data set has changed, the logical and physical data can be updated and a new dynamic view generated. In this example, step 802 comprises receiving a request to update the dynamic data view based on a change to the metric. For example, a business user may request an update to the sales data view after a new sales report is generated. In another example, a data analyst may request an update to the customer data view after new customer data is obtained. In an embodiment, the request comprises a model query language. Step 804 comprises determining the change to the metric. In an example, the change may be a change in the metric itself, such as a change in the formula used to calculate the metric. In another example, the change may be a change in the data set, such as the addition or removal of data. Step 806 comprises updating the logical data model to reflect the change in the metric. In an example, if the metric has changed, the logical data model may need to be updated to reflect the new formula used to calculate the metric. In another example, if the data set has changed, the logical data model may need to be updated to reflect the new data. For example, if the data set contains a new attribute or relationship, the logical data model may need to be updated to reflect this change. Alternatively, if the data set has changed in a way that affects the validity of the logical data model, the logical data model may need to be updated to reflect this change. Updating the logical data model can involve adding new entities or relationships, modifying existing entities or relationships, or removing entities or relationships. Step 808 comprises mapping the updated logical data model to the physical data model. In an example, if the logical data model has been updated, it may need to be remapped to the physical data model to ensure that the data is properly related and structured. Step 810 comprises updating the dynamic data view based on the updated logical and physical data models. In an example, the updated data models may be used to generate a new dynamic data view that reflects the changes to the metric and data set. In certain embodiments, machine learning algorithms can be utilized to detect and update the models.

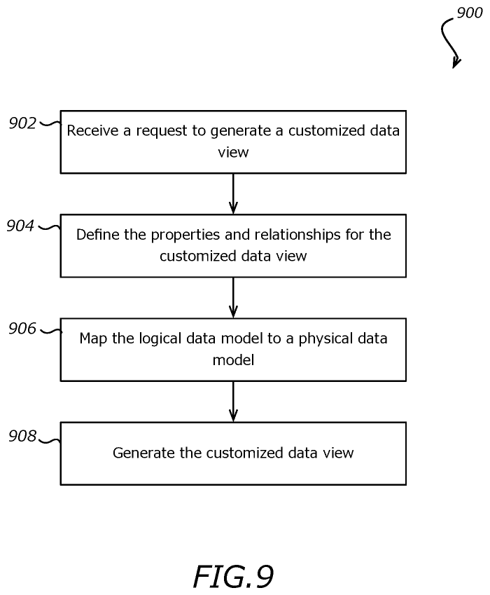

FIG. 9 illustrates an example process 900 for generating a customized data view in accordance with various embodiments. In this example, step 902 comprises receiving a request to generate a customized data view. In an example, a business user may request a customized data view that includes specific metrics and data sets. Step 904 comprises defining the properties and relationships for the customized data view. In an embodiment, this step includes defining the specific metrics and data sets requested by the user in step 902. The properties and relationships of the customized data view may be defined using a logical data model, which provides a conceptual representation of the data and defines how the data is related to each other. The logical data model may include entities, primary keys, foreign keys, and cardinality between tables. Step 906 comprises mapping the logical data model to a physical data model to generate standardized data. The mapping process can include preprocessing the data, cleaning, transforming, and mapping the data to a common format. This step can also involve correlating the data in a meaningful way to be understood and analyzed in the context of the logical data model. The mapping may be done according to a preconfigured file for the particular logical data model, which defines the entities in a schema using SQL queries. Step 908 comprises generating the customized data view. In an embodiment, the customized data view may be generated using data visualization applications that are compatible with the customized data view. The customized data view may be generated by ingesting the standardized data into the data visualization application, which generates a structured view of the data set. The customized data view can be provided in a format that is compatible with the data visualization application or may be provided in a customized format.

In certain embodiments, approaches described herein automatically generate a summary report based on the dynamic data view. The report can include key metrics, charts, and graphs to help users quickly understand the data and identify trends. Users can customize the report to their specific needs, and the system can generate the report on a regular schedule or upon request. In an embodiment, approaches described herein can use machine learning algorithms to generate predictions based on the data set. For example, the system can use historical data to predict future sales or customer behavior. Users can customize the prediction models to suit their specific needs, and the system can provide visualizations to help users understand the predictions. In an embodiment, approaches described herein can use machine learning algorithms to generate recommendations based on the data set. For example, the system can recommend products to customers based on their purchase history or recommend marketing strategies based on sales data. Users can customize the recommendation models to suit their specific needs, and the system can provide visualizations to help users understand the recommendations. In an embodiment, approaches described herein can optimize the data pipelines used to obtain the data set for a particular ontology. The system can automatically adjust the data pipelines based on changes in the data set or changes in the ontology to improve performance and efficiency. For example, the system can identify bottlenecks in the data pipelines and suggest ways to optimize them. In an embodiment, approaches described herein can automatically update the logical data model based on changes in the data set or changes in the ontology. The system can identify new entities or relationships in the data set and update the logical data model accordingly. Users can review and approve the changes before they are implemented.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

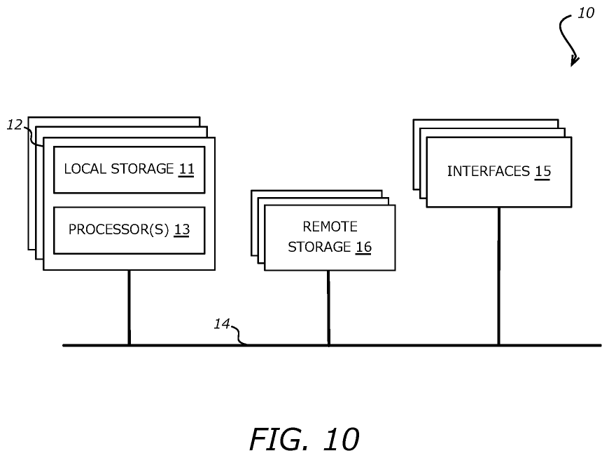

Referring now to FIG. 10 above, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 10 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a JAVA virtual machine or equivalent, or files containing higher level code that may be executed by the computer using an interpreter (for example, scripts written in Python, Perl, Ruby, Groovy, or any other scripting language).

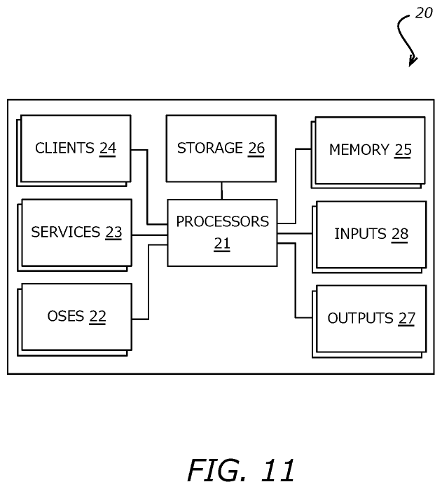

In some embodiments, systems may be implemented on a standalone computing system. Referring now to FIG. 11 above, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 10). Examples of storage devices 26 include flash memory, magnetic hard drive, CD-ROM, and/or the like.

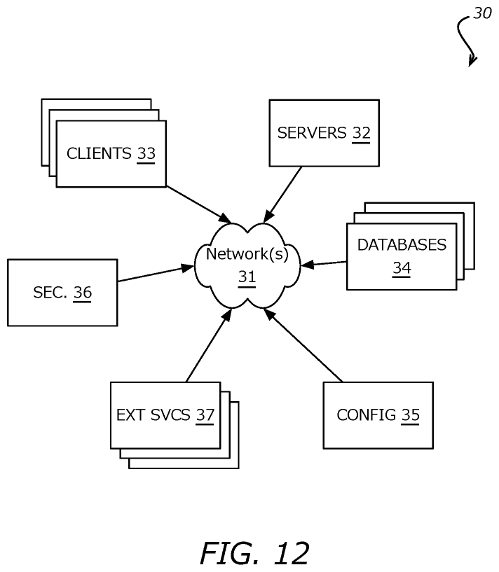

In some embodiments, systems may be implemented on a distributed computing network, such as one having any number of clients and/or servers. Referring now to FIG. 12 above, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 12. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

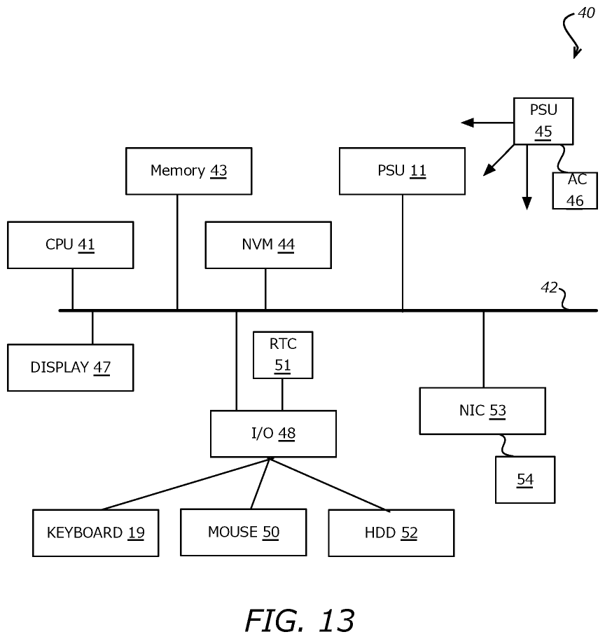

FIG. 13 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### ADDITIONAL CONSIDERATIONS

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

Various apparent modifications, changes and variations may be made in the arrangement, operation and details of the method and apparatus disclosed herein without departing from the spirit and scope defined in the appended claims.

What is claimed is:

1. A computer-implemented method, comprising:
receiving a request to generate a dynamic data view of a data set based at least in part on a metric, the data set being maintained across a plurality of data stores connected via a network, the data set being stored in a non-standardized format and not correlated;
receiving a preconfigured file defining a logical data model for the dynamic data view;
defining logics for the metric;
mapping the logical data model to a physical data model to generate standardized data such that the data set is correlated to the logical data model for the dynamic data view, the physical data model being associated with the plurality of data stores; and
generating the dynamic data view, the dynamic data view providing a structured view of the data set maintained across the plurality of data stores.

2. The computer-implemented method of claim 1, wherein the dynamic data view is ingested by one of a plurality of data visualization applications.

3. The computer-implemented method of claim 1, wherein defining the logical data model includes defining properties of the data set and relationships between the data set for the dynamic data view.

4. The computer-implemented method of claim 1, wherein the preconfigured file comprises a schema for the logical data model.

5. The computer-implemented method of claim 1, wherein the logical data model is associated with one of a schema of entities, primary keys, foreign keys, or cardinality between tables.

6. The computer-implemented method of claim 1, further comprising:
writing the logical data model.

7. The computer-implemented method of claim 1, further comprising:
utilizing a plurality of data pipelines to obtain the data set for a particular ontology, and wherein an ontology defines source data required for one or more metrics or key performance indicators.

8. The computer-implemented method of claim 7, further comprising:
determining empty data fields from the dynamic data view based on the ontology.

9. The computer-implemented method of claim 1, wherein the request is received by a data view layer, the request being defined using a data view query language, the data view query language including at least one of model query language (MQL) or lens query language (LQL).

10. The computer-implemented method of claim 1, further comprising:
obtaining a third-party data schema;
generating the dynamic data view based on the third-party data schema; and
transmitting data based on the dynamic data view.

11. The computer-implemented method of claim 1, further comprising:
providing the dynamic data view for purchase or rent.

12. The computer-implemented method of claim 1, further comprising:
updating the dynamic data view based on a change to the metric.

13. A computer system for generating dynamic data views of a data set, the computer system comprising:
a processor configured to receive a request to generate a dynamic data view based at least in part on a metric, the data set being maintained across a plurality of data stores connected via a network;
a memory storing a preconfigured file defining a logical data model for the dynamic data view;
a logic module configured to define logics for the metric;
a mapping module configured to map the logical data model to a physical data model, the physical data model being associated with the plurality of data stores; and
a generation module configured to generate the dynamic data view, the dynamic data view providing a structured view of the data set maintained across the plurality of data stores.

14. The computer system of claim 13, further comprising a data visualization module configured to ingest the dynamic data view into one of a plurality of data visualization applications.

15. The computer system of claim 13, further comprising a logic module configured to define properties of the data set and relationships between the data set for the dynamic data view.

16. The computer system of claim 13, further comprising a data model module configured to associate the logical data model with one of a schema of entities, primary keys, foreign keys, or cardinality between tables.

17. The computer system of claim 13, further comprising a data view layer configured to receive a request to generate the dynamic data view, the request being defined using a data view query language including at least one of model query language (MQL) or lens query language (LQL).

18. A non-transitory computer readable storage medium storing instructions that, when executed by at least one processor of a computing system, causes the computing system to:
receive a request to generate a dynamic data view of a data set based at least in part on a metric, the data set being maintained across a plurality of data stores connected via a network;
receive a preconfigured file defining a logical data model for the dynamic data view;
define logics for the metric;
map the logical data model to a physical data model, the physical data model being associated with the plurality of data stores; and
generate the dynamic data view, the dynamic data view providing a structured view of the data set maintained across the plurality of data stores.

19. The non-transitory computer readable storage medium of claim 18, wherein the instructions, when executed by the at least one processor to define the logical data model, further enables the computing system to:
define properties of the data set and relationships between the data set for the dynamic data view.

20. The non-transitory computer readable storage medium of claim 18, wherein the instructions, when executed by the at least one processor, further enables the computing system to:
determine empty data fields from the dynamic data view based on an ontology.
